(19) United States
(12) Patent Application Publication
(10) Pub. No.: US 2025/0229730 A1
(43) Pub. Date: Jul. 17, 2025

(54) COMPONENT FOR VEHICLE INTERIOR

(71) Applicant: Yanfeng International Automotive Technology Co. Ltd., Novi, MI (US)

(72) Inventors: Jennifer A. Stroebe, Holland, MI (US); Dale Todd Glynn, Allendale, MI (US)

(21) Appl. No.: 19/171,156

(22) Filed: Apr. 4, 2025

Related U.S. Application Data
(63) Continuation of application No. PCT/US2023/034408, filed on Oct. 3, 2023.
(60) Provisional application No. 63/460,371, filed on Apr. 19, 2023.
(60) Provisional application No. 63/413,800, filed on Oct. 6, 2022.

(51) Int. Cl. B60R 13/02

(52) U.S. Cl. CPC B60R 13/0256

(57) ABSTRACT

A component for a vehicle interior is disclosed. The component may comprise a composite structure comprising a substrate and a cover comprising a cover layer; the substrate may comprise a fiber panel formed into a compressed fiber panel; the cover layer may comprise an exterior surface and a feature providing a decorative effect; the feature may comprise a stitch pattern; the stitch pattern may comprise a top stitch at the cover surface coupled with a bottom stitch at the substrate. The feature may comprise an indentation in the outer surface of the cover layer and/or a projection at the outer surface of the cover layer. The cover layer may comprise a formed/molded skin layer. The substrate may comprise a structural substrate comprising a rigid compression-formed fiber panel. The cover layer may comprise a material softer than the rigid compression-formed fiber panel of the structural substrate.

### CROSS-REFERENCE TO RELATED APPLICATIONS

The present application is a continuation of PCT/International Patent Application No. PCT/US23/34408 titled “COMPONENT FOR VEHICLE INTERIOR” filed Oct. 3, 2023, which claims the benefit of U.S. Provisional Patent Application No. 63/413,800 titled “COMPONENT FOR VEHICLE INTERIOR” filed Oct. 6, 2022 and U.S. Provisional Patent Application No. 63/460,371 titled “COMPONENT FOR VEHICLE INTERIOR” filed Apr. 19, 2023.

The present application claims priority to and incorporates by reference in full the following patent applications: (a) U.S. Provisional Patent Application No. 63/413,800 titled “COMPONENT FOR VEHICLE INTERIOR” filed Oct. 6, 2022; (b) U.S. Provisional Patent Application No. 63/460,371 titled “COMPONENT FOR VEHICLE INTERIOR” filed Apr. 19, 2023; (c) PCT/International Patent Application No. PCT/US23/34408 titled “COMPONENT FOR VEHICLE INTERIOR” filed Oct. 3, 2023.

### FIELD

The present invention relates to a component for a vehicle interior.

### BACKGROUND

Vehicle interior components may comprise trim parts which are provided throughout the interior of a typical passenger vehicle. Interior components may provide visible surfaces facing and defining the interior of the vehicle. Interior components may cover, conceal and protect functional components such as within the doors, behind the dashboard, at the center console, etc. Stitching may be applied to the surfaces of components visible in the interior of a vehicle; stitching may indicate handcrafted detail and may signify product quality (e.g. combination with visible cover materials and surfaces). It is known to provide a component for a vehicle interior comprising a cover joined to a substrate. It is known to provide a vehicle interior component comprising a seam configured to join two materials. It is known to provide a vehicle interior component comprising a depression configured to simulate the joining of two materials using a single material. It is known to provide a vehicle interior component comprising a single material that simulates two materials sewn together. It is known to provide a component for a vehicle interior comprising a cover with an icon or an image.

It would be advantageous to provide an improved component for a vehicle interior.

It would be advantageous to provide for manufacturing of a component for a vehicle interior simulating functional seams/stitching without the use of multiple cover materials and without the need to join different materials.

It would be advantageous to provide for manufacturing of a component for a vehicle interior comprising a cover with an integrally-formed icon/indicia or image.

### SUMMARY

The present invention relates to a component for a vehicle interior configured to comprise a composite structure may comprise a substrate and a cover. The substrate may comprise a fiber panel formed into a compressed fiber panel. The cover may comprise a cover layer on the substrate. The cover layer may comprise an outer surface may comprise an exterior surface for the composite structure. The cover layer may comprise a feature at the outer surface may comprise a decorative effect. The feature of the cover layer may comprise a stitch pattern provided at the outer surface of the cover layer. The stitch pattern may comprise a top stitch at the outer surface coupled with a bottom stitch at the substrate. The stitch pattern may be formed into the cover layer and the substrate. The feature of the cover layer may comprise an indentation in the outer surface of the cover layer and/or a projection at the outer surface of the cover layer. The feature of the cover layer may comprise an indentation may comprise a recess in the outer surface of the cover layer. The feature of the cover layer may comprise a groove in the outer surface of the cover layer. The feature of the cover layer may comprise a rib on the outer surface of the cover layer. The feature of the cover layer may be below the exterior surface of the cover layer and/or the feature of the cover layer may be above the exterior surface of the cover layer. The cover layer may comprise a skin layer formed on the substrate. The skin layer may comprise a molded thermoplastic material. The stitch pattern may comprise a stitch through the cover layer and into the substrate. The stitch pattern may be within a recess at the outer surface of the cover. The substrate may comprise a structural substrate. The structural substrate may comprise the compressed fiber panel. The compressed fiber panel may comprise a compression-formed panel. The compression-formed panel may comprise a rigid compressed fiber panel. The cover layer may comprise a material softer than a material of the substrate. The decorative effect of the feature of the cover layer of the cover may comprise at least one of indicia and an image and an icon and a logo and a visual effect and a seam and a simulated seam and a simulated stitch and the stitch pattern adjacent a feature and the stitch pattern adjacent an indentation and the stitch pattern adjacent a projection etc.

The present invention relates to a component for a vehicle interior configured to comprise a composite structure may comprise a substrate formed from a fiber panel and a cover for the substrate may comprise a skin layer. The stitch pattern may be formed into the skin layer and the substrate. The skin layer may comprise an inner surface coupled to the substrate and an outer surface providing an exterior surface. The skin layer may comprise a feature may comprise an indentation in the outer surface of the skin layer and/or a projection in the outer surface of the skin layer. The stitch pattern and the feature in the outer surface of the skin layer may be configured to provide a visual effect at the exterior surface. The stitch pattern may comprise a top stitch at the cover surface coupled with a bottom stitch at the substrate. The indentation may be formed as a recess in the outer surface of the skin layer. The skin layer may comprise a molded thermoplastic material. The skin layer may comprise a skin material and the skin material may be softer than the substrate. The component may be made by a method may comprise the steps of providing the fiber panel as a pre-form substrate in a mold tool and compressing the pre-form substrate within the mold tool to form the pre-form substrate into a compression-formed panel having a shape and molding the skin layer of the cover on the compression-formed panel. The feature may be provided at the outer surface of the skin layer by providing the stitch pattern on the fiber panel and/or by forming an indentation and/or projection with the compression-formed panel. The outer surface of the skin layer of the cover may comprise the exterior surface of the composite structure. The composite structure may comprise the stitch pattern adjacent to the feature of the skin layer. The component may comprise at least one of an instrument panel and a dashboard and a door panel and a steering wheel assembly and a console and a cockpit and a knee bolster and a trim panel and a trim component etc.

The present invention relates to a component for a vehicle interior comprising a composite structure comprising a substrate and a cover. The substrate may comprise a panel. The cover may comprise a cover layer. The cover layer may comprise an inner surface and an outer surface. The outer surface of the cover layer may comprise an exterior surface for the composite structure. The cover layer may comprise a feature in the outer surface of the cover layer. The panel may comprise a fiber panel. The substrate may comprise a compressed fiber panel. The feature of the cover layer may comprise at least one of (a) an indentation in the outer surface of the cover layer and (b) a projection in the outer surface of the cover layer. The cover layer may comprise a projection in the outer surface of the cover layer. The cover layer may comprise a recess in the outer surface of the cover layer. The feature of the cover layer may comprise a recess in the outer surface of the cover layer and a projection in the outer surface of the cover layer. The recess may be formed in the outer surface of the cover layer. The projection may be formed in the outer surface of the cover layer. The feature of the cover layer may comprise a groove in the outer surface of the cover layer. The feature of the cover layer may comprise a rib on the outer surface of the cover layer. The feature of the cover layer may comprise an indentation in the outer surface of the cover layer and a rib in the outer surface of the cover layer. The feature of the cover layer may be below the exterior surface of the cover layer. The feature of the cover layer may comprise an indentation below the exterior surface of the cover layer. The feature of the cover layer may be above the exterior surface of the cover layer. The feature of the cover layer may comprise a projection above the exterior surface of the cover layer. The cover may comprise a resin. The cover layer may comprise a skin layer. The inner surface of the cover layer may be coupled to the substrate. The cover layer may be formed on the substrate. The cover layer may be molded on the substrate. The cover layer may be molded around the substrate. The composite structure may comprise a stitch pattern. The stitch pattern may be formed into the cover layer and the substrate. The feature of the cover layer may comprise a stitch pattern provided at the outer surface of the cover layer. The stitch pattern may comprise a stitch through the inner surface of the cover layer. The stitch pattern may be within a recess at the outer surface of the substrate. The stitch pattern may be provided through a top surface of the substrate. The stitch pattern may be below the outer surface of the cover layer. The stitch pattern may be above the outer surface of the cover layer. The stitch pattern may be within a groove in the outer surface of the cover layer. A feature may be provided in a top surface of the substrate. The feature in the top surface of the substrate may comprise at least one of a projection or a recess. The substrate may comprise a structural substrate. The structural substrate may comprise a compression-formed panel. The compression-formed panel of the structural substrate may comprise a rigid compressed fiber panel. The substrate may comprise a semi-rigid compressed fiber panel. The cover layer may comprise a material softer than a material of the substrate. The composite structure may be configured to provide a decorative effect; the decorative effect may comprise a stitch pattern. The composite structure may comprise a stitch pattern; the stitch pattern may be formed into the cover layer and the substrate. The stitch pattern may be adjacent the feature of the cover layer. The stitch pattern may be in a groove in the outer surface of the cover layer. The stitch pattern and the feature of the cover layer may be configured to provide a decorative effect. The stitch pattern and the feature of the cover layer may be configured to provide a visual effect; the visual effect may comprise at least one of: (a) a simulated seam; (b) a simulated French seam; (c) a simulated deck seam. The feature of the cover layer may comprise a projection and/or an indentation. The composite structure may comprise a stitch pattern adjacent to the feature of the cover layer. The composite structure may comprise a stitch pattern at the feature of the cover layer. The composite structure may comprise a stitch pattern through the feature of the cover layer. The feature of the cover layer may comprise at least one of (a) indicia; (b) an image; (c) an icon; (d) a logo. The composite structure may comprise the cover layer formed on the substrate; the feature of the cover layer may be configured to provide the exterior surface of the cover layer with a visual effect. The composite structure may comprise the cover layer (a) formed on the substrate or (b) molded on the substrate. The composite structure may comprise the cover layer (a) molded partially around the substrate; (b) molded laterally around the substrate; (c) molded on and at least partially under the substrate. The cover layer may be molded on the substrate; the cover layer may comprise an injection molded thermoplastic material. The cover layer may comprise at least one of (a) a TPE material; (b) a TPV material; (c) a PU material. The feature of the cover layer may comprise a formed projection. The formed projection may comprise at least one of (a) an image; (b) an icon. The feature of the cover layer may comprise a formed recess. The composite structure may be configured to provide an opening for deployment of an airbag through the opening. The component may comprise at least one of (a) an instrument panel; (b) a dashboard; (c) a door panel; (d) a steering wheel assembly; (e) a console; (f) a cockpit; (g) a knee bolster; (h) a trim component.

The present invention relates to a component for a vehicle interior comprising a substrate formed from a fiber panel; and a cover for the substrate comprising a skin layer. The skin layer may comprise an inner surface coupled to the substrate and an outer surface providing an exterior surface. The skin layer may comprise at least one of: (a) an indentation in the outer surface of the skin layer; (b) a protrusion in the outer surface of the skin layer. The indentation may be formed as a recess in the outer surface of the skin layer. The skin layer may be molded on the substrate. The skin layer may comprise an injection molded thermoplastic material. The skin layer may comprise at least one of (a) a TPE material; (b) a TPV material; (c) a PU material. The skin layer may comprise a skin material; the skin material may be softer than the substrate. The component may comprise a stitch pattern formed into the skin layer and the substrate. The stitch pattern and the indentation in the outer surface of the skin layer may be configured to provide a visual effect comprising at least one of: (a) a simulated seam; (b) a simulated French seam; (c) a simulated deck seam. The stitch pattern and the protrusion in the outer surface of the skin layer may be configured to provide a visual effect comprising at least one of: (a) a simulated seam; (b) a simulated French seam; (c) a simulated deck seam. The protrusion in the outer surface of the skin layer may comprise at least one of (a) an image; (b) an icon.

The present invention relates to a component for a vehicle interior formed in a mold comprising (a) a substrate comprising a compression-formed component; and (b) a cover comprising a skin layer. The compression-formed component may be formed by compressing a fiber panel between a first surface of the mold and a second surface of the mold. The skin layer may be formed by molding the skin layer on the compression-formed component. The cover may comprise a feature comprising at least one of (a) a recess in an outer surface of the cover and (b) a projection in the outer surface of the cover. The component may comprise a composite structure comprising the substrate and the cover; the composite structure may comprise a stitch pattern adjacent to the feature of the cover.

The present invention relates to a method of manufacturing a component for a vehicle interior in a mold comprising: (a) providing a pre-form substrate; (b) disposing the pre-form substrate onto a first surface of the mold; (c) compressing the pre-form substrate between the first surface of the mold and a second surface of the mold to form the pre-form substrate into a compression-formed component having a shape corresponding to a first contour of the first surface and a second contour of the second surface; and (d) molding a skin layer on the compression-formed component. The step of molding a skin layer on the compression-formed component may comprise molding the skin layer between the compression-formed component and a third surface of the mold; the third surface of the mold may be configured to form at least one of: (a) an indentation in the outer surface of the skin layer; (b) a protrusion in the outer surface of the skin layer. The step of molding a skin layer on the compression-formed component may comprise molding the skin layer on a top surface of the compression-formed component and on an edge of the compression-formed component. The method may comprise a step of forming a stitch pattern into the skin layer and the compression-formed component. A component made by the method may comprise a composite structure comprising a structural substrate formed from the pre-form substrate and a cover comprising the skin layer. An outer surface of the skin layer of the cover may comprise an exterior surface of the composite structure; the composite structure may comprise a stitch pattern adjacent to a feature of the cover layer.

The present invention relates to a component for a vehicle interior comprising a substrate formed from a fiber panel and a cover for the substrate comprising a skin layer. The skin layer may comprise an inner surface coupled to the substrate and an outer surface providing an exterior surface of the component. The skin layer may comprise at least one of: (a) an indentation in the outer surface of the skin layer; (b) a protrusion in the outer surface of the skin layer. The indentation may be formed as a recess in the skin layer. The skin layer may comprise a protrusion in the inner surface of the skin layer opposite the indentation in the outer surface of the skin layer. The protrusion in the inner surface of the skin layer may be configured to fit within an indentation in a top surface of the substrate. The indentation in the top surface of the substrate may be formed in the fiber panel. The skin layer may be molded on the substrate. The skin layer may comprise an injection molded thermoplastic material. The skin layer may comprise a generally opaque material. The skin layer may comprise at least one of (a) a TPE material; (b) a TPV material; (c) a PU material. The skin layer may comprise a skin material; the skin material may be softer than the substrate. The fiber panel may comprise a panel comprising fibers. The fiber panel may be configured to provide an opening for deployment of an airbag through the opening. A rear side of the fiber panel may be configured for contact from the airbag to establish the opening for deployment of the airbag. The rear side of the panel may be configured to support an airbag module comprising the airbag. The substrate may comprise at least one feature at a rear side of the panel. The at least one feature may comprise at least one of (a) a resin; (b) a thermoplastic resin; (c) polypropylene; (d) acrylonitrile butadiene styrene; (e) polycarbonate. The at least one feature may be formed on the rear side of the panel. The at least one feature may comprise at least one of (a) an airbag chute; (b) a passage for the airbag; (c) a feature configured to facilitate the opening; (d) a structure for an airbag door; (e) a set of ribs configured to establish a seam for an airbag door; (f) a weld rib configured to couple an airbag chute to the panel. The substrate may comprise a compression-formed component from the fiber panel. The component may comprise a stitch pattern. The stitch pattern may be formed into the skin layer and the substrate. The stitch pattern may be adjacent the protrusion in the outer surface of the skin layer. The stitch pattern and the protrusion in the outer surface of the skin layer may be configured to provide a visual effect comprising at least one of: (a) a simulated seam; (b) a simulated French seam; (c) a simulated deck seam. The substrate may comprise at least one feature formed on a rear side of the panel. The at least one feature may comprise at least one of (a) a resin; (b) a thermoplastic resin; (c) polypropylene; (d) acrylonitrile butadiene styrene; (e) polycarbonate. The at least one feature may comprise at least one of (a) a rib; (b) a set of ribs; (c) a resin-formed feature; (d) a resin-formed feature molded on the substrate. The protrusion in the outer surface of the skin layer may comprise at least one of (a) an image; (b) an icon. The indentation in the outer surface of the skin layer may comprise a groove. The component may comprise at least one of (a) an instrument panel; (b) a dashboard; (c) a door panel; (d) a steering wheel assembly; (e) a console; (f) a cockpit; (g) a knee bolster; (h) a trim component.

The present invention relates to a component for a vehicle interior formed in a mold comprising a substrate comprising a compression-formed component and a cover comprising a skin layer. The compression-formed component may be formed by compressing a fiber panel between a first surface of the mold and a second surface of the mold. The skin layer may be formed by molding the skin layer on the compression-formed component.

The present invention relates to a method of manufacturing a component for a vehicle interior in a mold comprising providing a pre-form substrate; disposing the pre-form substrate onto a first surface of the mold; compressing the pre-form substrate between the first surface and a second surface of the mold to form the pre-form substrate into a compression-formed component having a shape corresponding to a first contour of the first surface and a second contour of the second surface; and molding a skin layer on the compression-formed component. The method may comprise a step of injecting resin into the mold to form a feature on a rear side of the compression-formed component. The method may comprise a step of injecting resin into the mold to form a feature on a rear side of the compression-formed component. The step of molding a skin layer on the compression-formed component may comprise molding the skin layer between the compression-formed component and a third surface of the mold. The third surface of the mold may be configured to form at least one of (a) an indentation in the outer surface of the skin layer; (b) a protrusion in the outer surface of the skin layer. The step of molding a skin layer on the compression-formed component may comprise molding the skin layer on a top surface of the compression-formed component and on an edge of the compression-formed component. The step of compressing the pre-form substrate between the first surface of the mold and the second surface of the mold may comprise forming an indentation a top surface of the compression-formed component.

The present invention relates to a component for a vehicle interior comprising a composite structure comprising a substrate and a cover comprising a cover layer; the substrate may comprise a fiber panel formed into a compressed fiber panel; the cover layer may comprise an exterior surface and a feature providing a decorative effect; the feature may comprise a stitch pattern; the stitch pattern may comprise a top stitch at the cover surface coupled with a bottom stitch at the substrate. The feature may comprise an indentation in the outer surface of the cover layer and/or a projection at the outer surface of the cover layer. The cover layer may comprise a formed/molded skin layer. The substrate may comprise a structural substrate comprising a rigid compression-formed fiber panel. The cover layer may comprise a material softer than the rigid compression-formed fiber panel of the structural substrate.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIG. 2A is a schematic perspective view of a component for a vehicle interior shown as an instrument panel and a component for a vehicle interior shown as a steering wheel according to an exemplary embodiment.

FIG. 2B is a schematic perspective view of a component for a vehicle interior shown as a door panel according to an exemplary embodiment.

FIG. 2C is a schematic partial section perspective view of a component for a vehicle interior shown as a door panel according to an exemplary embodiment.

FIG. 3 is a schematic exploded perspective view of a component for a vehicle interior according to an exemplary embodiment.

FIG. 4 is a schematic exploded perspective view of a component for a vehicle interior according to an exemplary embodiment.

FIG. 5 is a schematic partial section view of a component for a vehicle interior according to an exemplary embodiment.

FIG. 6 is a schematic partial section view of a component for a vehicle interior according to an exemplary embodiment.

FIG. 7 is a schematic partial section view of a component for a vehicle interior according to an exemplary embodiment.

FIG. 8 is a schematic partial section view of a component for a vehicle interior according to an exemplary embodiment.

FIG. 9 is a schematic partial section view of a component for a vehicle interior according to an exemplary embodiment.

FIG. 10 is a schematic partial section view of a component for a vehicle interior according to an exemplary embodiment.

FIG. 11 is a schematic partial section view of a component for a vehicle interior according to an exemplary embodiment.

FIG. 12 is a schematic partial section view of a component for a vehicle interior according to an exemplary embodiment.

FIG. 13 is a schematic partial section view of a component for a vehicle interior according to an exemplary embodiment.

FIG. 14 is a schematic partial section view of a component for a vehicle interior according to an exemplary embodiment.

FIG. 15 is a schematic partial section view of a component for a vehicle interior according to an exemplary embodiment.

FIG. 16 is a schematic partial section view of a component for a vehicle interior according to an exemplary embodiment.

FIG. 17 is a schematic partial section view of a component for a vehicle interior according to an exemplary embodiment.

FIG. 18 is a schematic partial section view of a component for a vehicle interior according to an exemplary embodiment.

FIGS. 19A and 19B are schematic perspective views of a fiber mat being compressed into a pre-form according to an exemplary embodiment.

FIGS. 19C to 19F are schematic perspective views of a pre-form being formed into a compression-formed component according to an exemplary embodiment.

FIGS. 20A to 20C are schematic perspective views of a fiber mat being formed into a component for a vehicle interior according to an exemplary embodiment.

FIG. 20D is a schematic section view of a component for a vehicle interior according to an exemplary embodiment.

FIG. 21A is schematic perspective view of a process to form a component for a vehicle interior according to an exemplary embodiment.

FIG. 21B is schematic partial section perspective view of a process to form a component for a vehicle interior according to an exemplary embodiment.

FIG. 21C is schematic partial section perspective view of a component for a vehicle interior according to an exemplary embodiment.

FIGS. 22A to 22E are schematic partial section views of a process to form a component for a vehicle interior according to an exemplary embodiment.

FIG. 23A is a schematic perspective view of a component for a vehicle interior according to an exemplary embodiment.

FIG. 23B is a schematic exploded perspective view of a component for a vehicle interior according to an exemplary embodiment.

FIGS. 24A through 24D are schematic perspective views of a fiber mat being formed into a component for a vehicle interior according to an exemplary embodiment.

FIGS. 25A and 25B are schematic partial section views a component for a vehicle interior according to an exemplary embodiment.

FIGS. 26A and 26B are schematic flow diagrams of forming a component for a vehicle interior according to an exemplary embodiment.

FIG. 27 is a schematic flow diagram of a method for forming a component for a vehicle interior according to an exemplary embodiment.

FIG. 28 is a schematic flow diagram of a method for forming a component for a vehicle interior according to an exemplary embodiment.

### DESCRIPTION

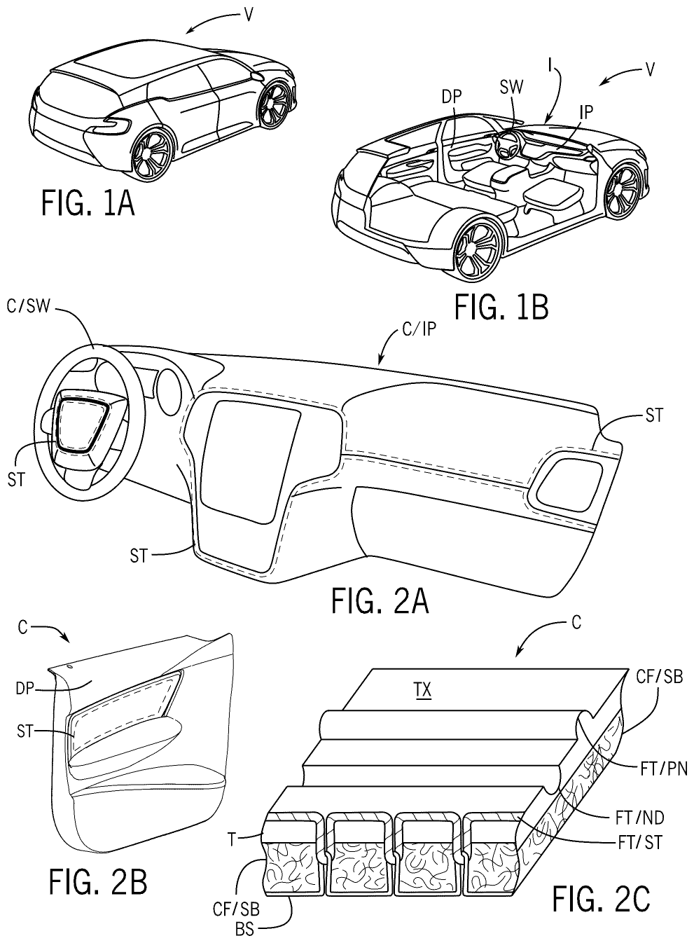

Referring to FIGS. 1A-1B and 2A-2C, a vehicle V with an interior I is shown comprising a component C shown as an instrument panel IP and a door/panel DP and a steering wheel SW (and other components such as panels, consoles, seating, etc.).

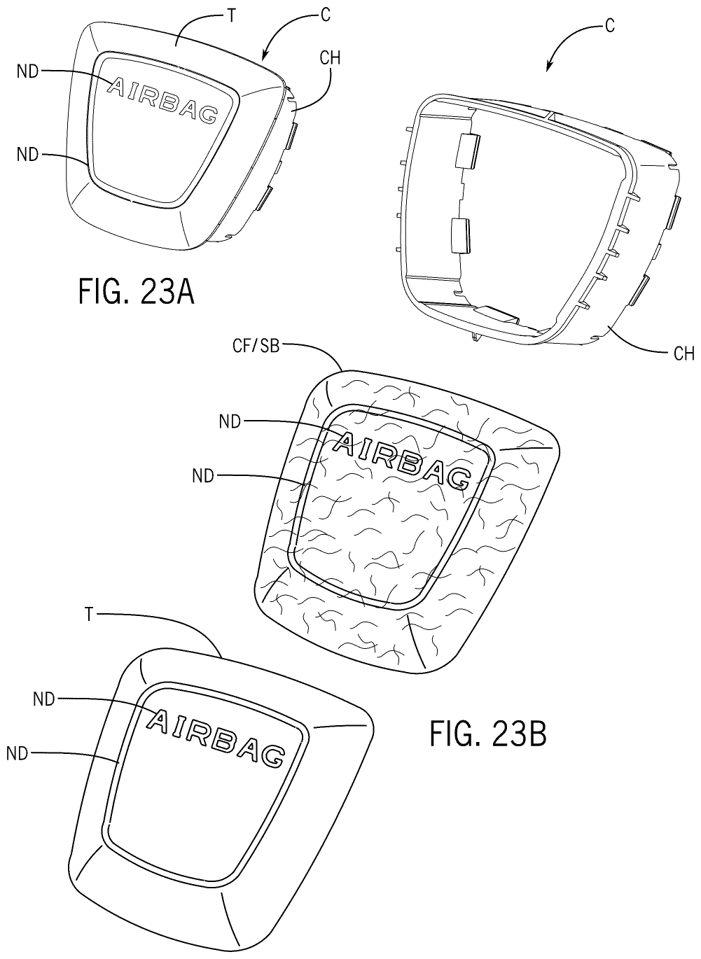

As shown schematically according to an exemplary embodiment in FIGS. 2A-2C, component C may comprise a composite structure configured to provide a visual/decorative effect at a exterior surface TX provided by a feature FT such as a stitch/stitch pattern ST and/or a projection/protrusion PN and/or an indentation/recess ND. As indicated schematically in FIGS. 2A-2C, 3, 4 and 23A-23B, the visual/decorative effect at the exterior surface of the component may comprise a shape/form such as a border presented by feature FT and/or an image/indicia such as an icon, logo, text, etc. presented by feature FT.

As shown schematically according to an exemplary embodiment in FIGS. 2C, 3, 4, 5, 6, 7, 8, 9, 10, 11, 12, 13, 14, 15, 16, 17 and 18, component C may comprise a composite structure comprising a base B and structure shown as a housing CH (such as an airbag chute) and a substrate SB shown as comprising panel CF (such as a compressed fiber panel) and a cover T configured to provide an exterior surface TX with arrangements and/or combinations of features FT shown as projection PN and indentation ND and stitch/stich pattern ST. As indicated schematically, the composite structure comprising substrate SB and cover T with arrangement of features FT may be configured to provide any of a variety of shapes/forms and visual/decorative effects for any of a variety of components in the interior of the vehicle; as indicated schematically, features such as projections/protrusions and indentations/recesses may be provided in any of a variety of forms and combinations of forms (e.g. ribs, ridges, nubs, bumps, connectors, holes, grooves, slots, borders, etc.).

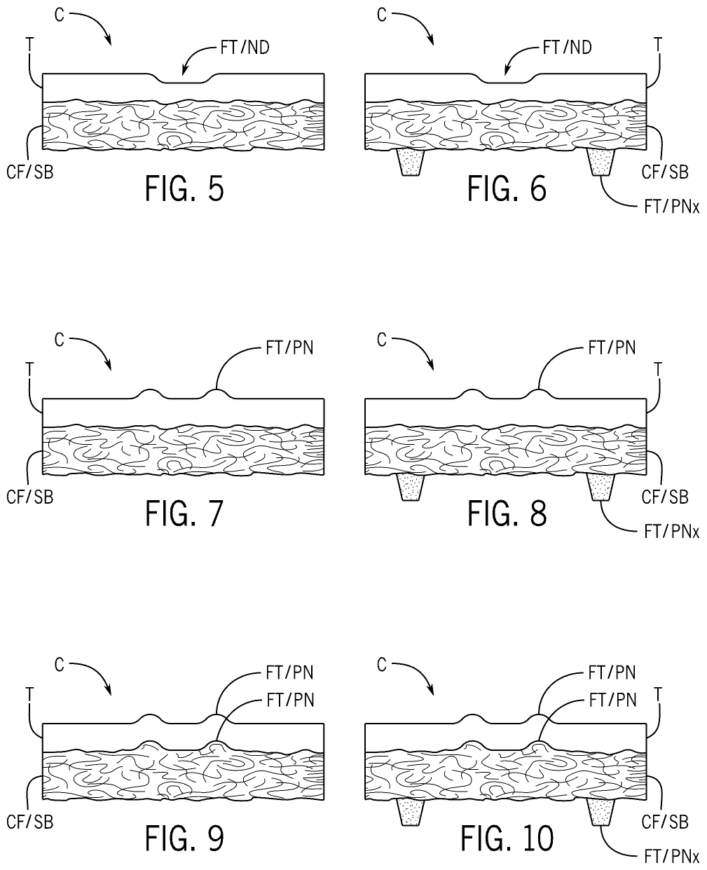

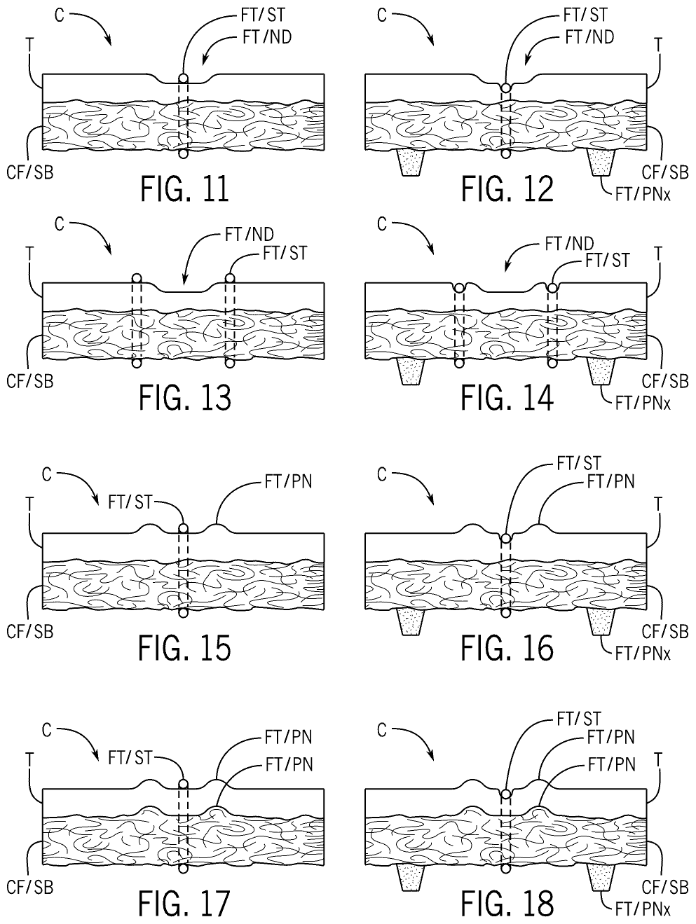

As indicated schematically in FIGS. 2C, 5, 6, 7, 8, 9, 10, 11, 12, 13, 14, 15, 16, 17 and 18, in the arrangement and/or combination of features FT at cover T providing exterior surface TX over substrate SB of the composite structure, the stitch pattern ST may be presented adjacent to an indentation ND shown as a groove and a projection PN shown as rib/ridge (FIG. 2C) or with an indentation ND below the level of the exterior surface of the cover T (FIGS. 5 and 6) or with a projection PN above the level of the exterior surface of the cover T (FIGS. 7, 8, 9 and 10) or with an indentation ND with a stitch pattern ST above the level of the indentation NC (FIG. 11) or with an indentation ND with a stitch pattern ST at/below the level of the indentation ND (FIG. 12) or with a set of projections PN with a stitch pattern ST above the level of the exterior surface of the cover T (FIGS. 15 and 17) or with a set of projections PN with a stitch pattern ST at/below the level of the exterior surface of cover T (FIGS. 16 and 18). As indicated schematically in FIGS. 9, 10, 17 and 18, the composite structure may comprise a feature FT shown as a projection PN on the upper surface of the substrate SB (shown as compressed fiber panel CF); the projection may comprise an integrally-formed feature with the substrate; projection PN of substrate SB may be aligned with projection PN of cover T. As indicated schematically in FIGS. 6, 8, 10, 12, 14, 16 and 18, the composite structure may comprise a feature FT shown as a projection arrangement comprising projection PNx on the lower surface of the substrate SB (shown as compressed fiber panel CF); the projection may comprise a formed feature and/or molded material.

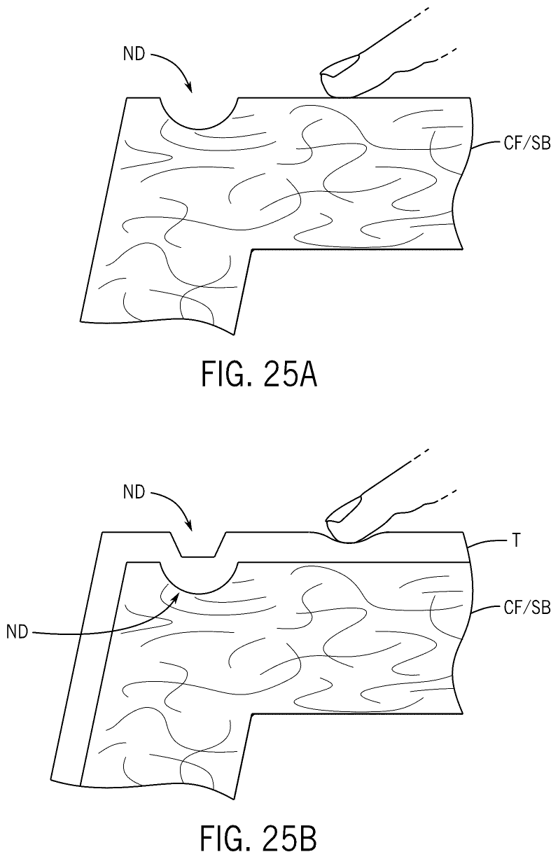

As indicated schematically in FIGS. 25A-25B, the composite structure may comprise a feature FT shown as an indentation ND in the upper surface of substrate SB (shown as compressed fiber panel CF); indentation ND of substrate SB may be aligned with an indentation ND of cover T. See also FIGS. 2A-2C, 3 and 4.

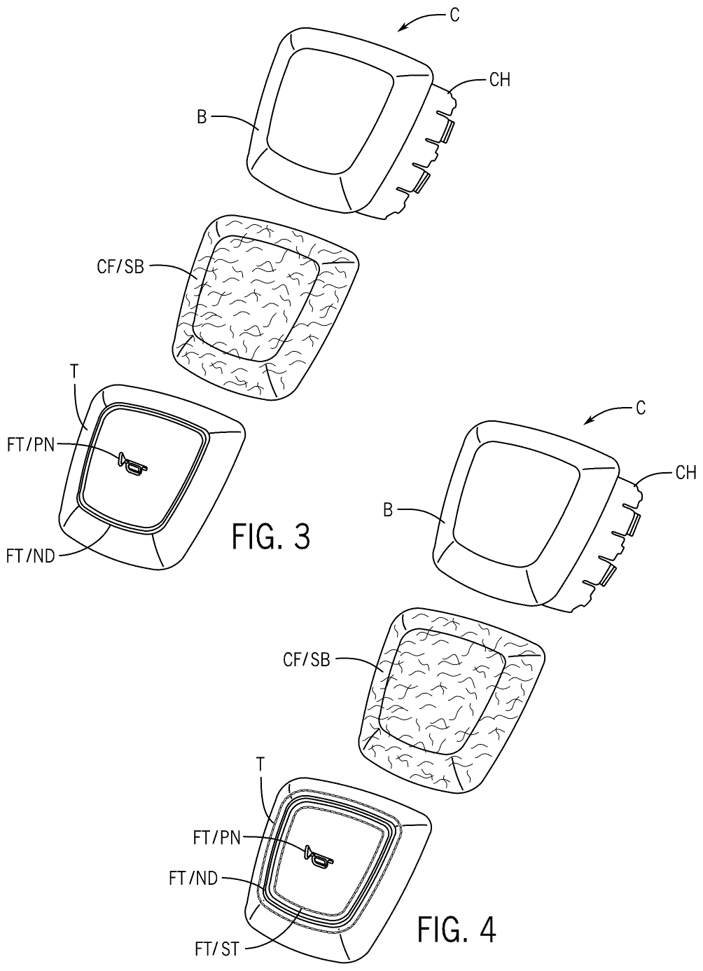

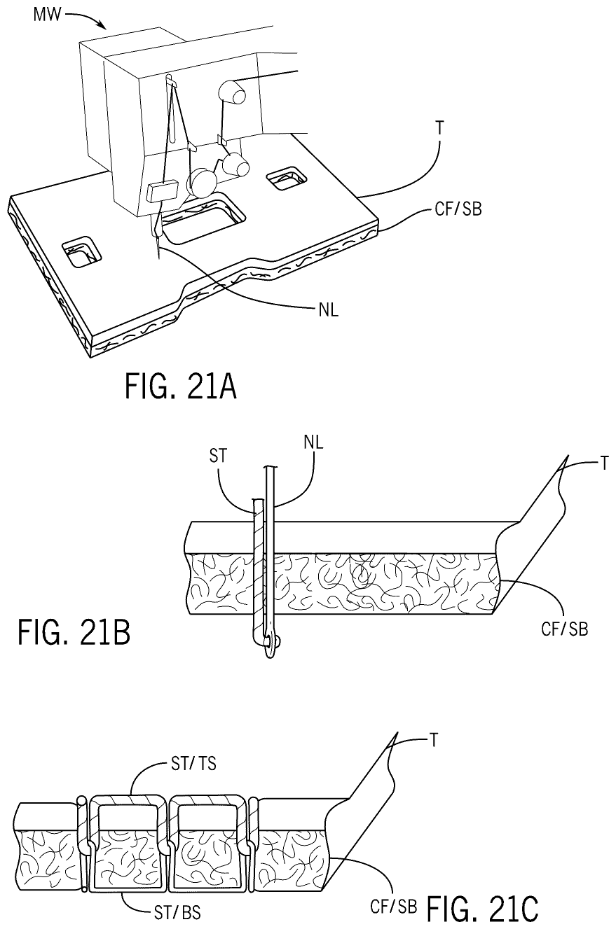

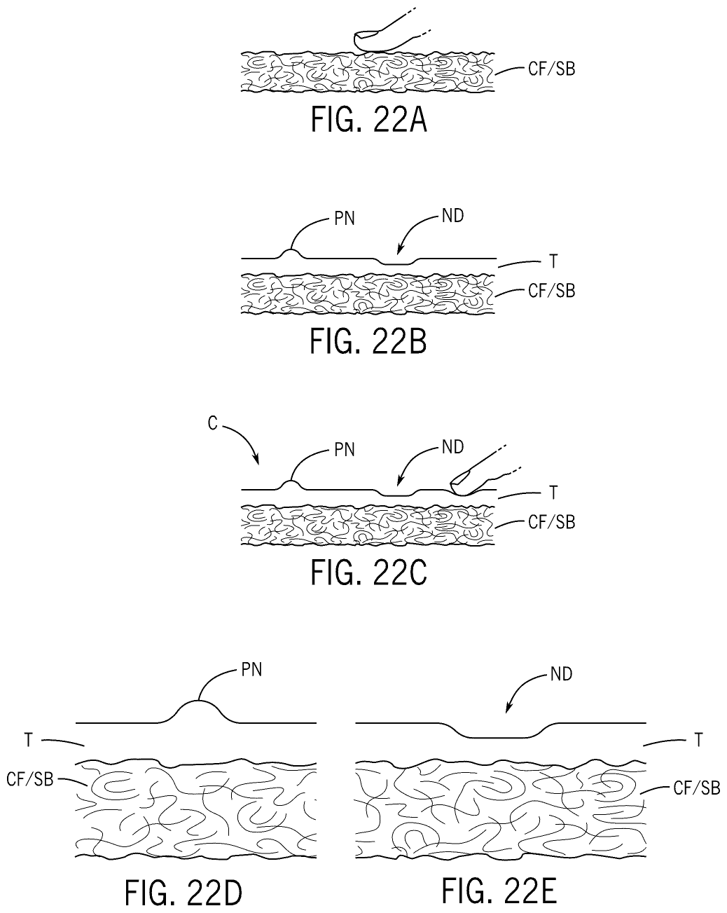

As indicated schematically in FIGS. 2A-2C, 3, 4, 22A-22E and 23A-23B, the features for the component may be arranged and/or combined in any of a wide variety of designs/shapes and configurations/arrangements (e.g. projections, indentations, stitch pattern, projection with indentations, projection with stitch pattern, projection with indentation and stitch pattern, indentation with stitch pattern, etc.); the features of the component may be arranged and/or combined to provide any of a wide variety of visual/decorative effects (e.g. by arrangement and/or combination to provide form, shape, texture, contour, relief, pattern, color, image/indicia, etc.) See also FIGS. 5, 6, 7, 8, 9, 10, 11, 12, 13, 14, 15, 16, 17 and 18. As indicated schematically in FIGS. 2A-2C, 3, 4, 21A-21C and 22A-22E, features FT for the composite structure comprising substrate SB (shown as compressed fiber panel CF) and cover T (providing the cover layer/exterior surface) for component C may be arranged and/or combined in any of a wide variety of designs/shapes and configurations/arrangements such as with a set of features FT comprising projection PN and indentation ND and a stitch pattern (see FIGS. 2C and 4) or with a set of features FT comprising projection PN and indentation ND (see FIGS. 3 and 22B-22C); feature FT may comprise a projection/protrusion PN (see FIG. 22D) or an indentation/recess ND (see FIG. 22E) or a stitch/stitch pattern ST (see FIGS. 2C and 21A-21C). As indicated schematically in FIGS. 2A-2C, 3, 4, 22A-22E and 25A-25B, a feature FT for the composite structure comprising substrate SB and cover T for component C may be arranged and/or combined in any of a wide variety of designs/shapes and configurations/arrangements and texture/resilience such as with a rigid substrate SB (shown as rigid compressed/treated fiber panel CF) and a compliant cover T (shown as a resilient/compressible material) providing features FT (see FIGS. 22A-22C and 25A-25B).

As indicated schematically according to an exemplary embodiment in FIGS. 2C, 4, 11, 12, 13, 14, 15, 16, 17, 18 and 21A-21C, the feature shown as stitch pattern ST may be formed in a variety of arrangements in/through substrate SB shown as compressed fiber panel CF and cover T of the composite structure of the component; as indicated schematically according to an exemplary embodiment in FIGS. 21A-21C, the stitch pattern may be applied by use of an apparatus shown as sewing machine MW with needle NL applying a stitch of stitch pattern ST shown as comprising a top stitch TS and a bottom stitch BS. See also FIGS. 2C and 4. As indicated schematically in FIGS. 2A-2B and 4, component C may comprise the composite structure providing the cover with the exterior surface comprising a visual/decorative effect provided by stitch pattern ST. See also FIGS. 2C and 21C.

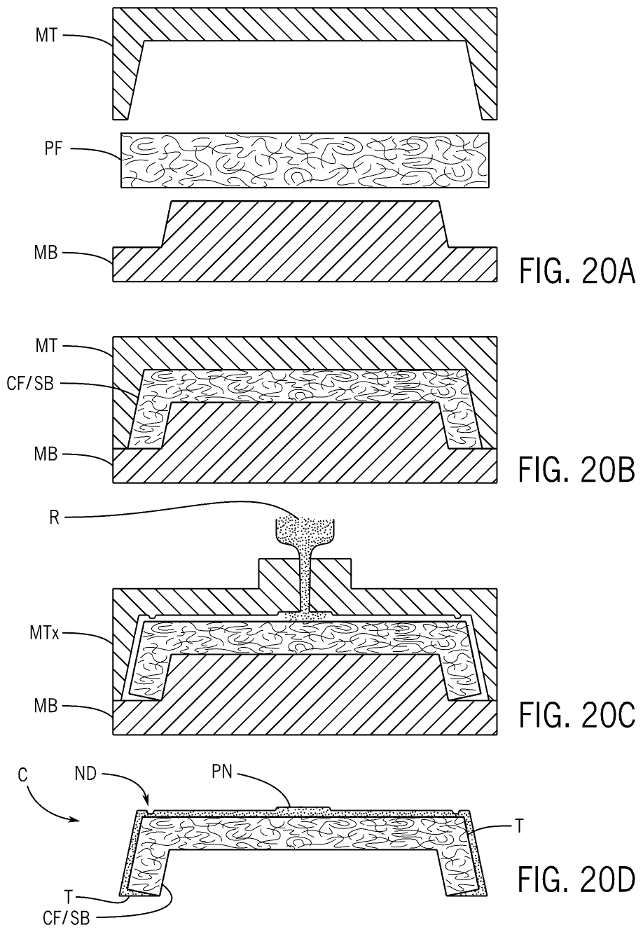

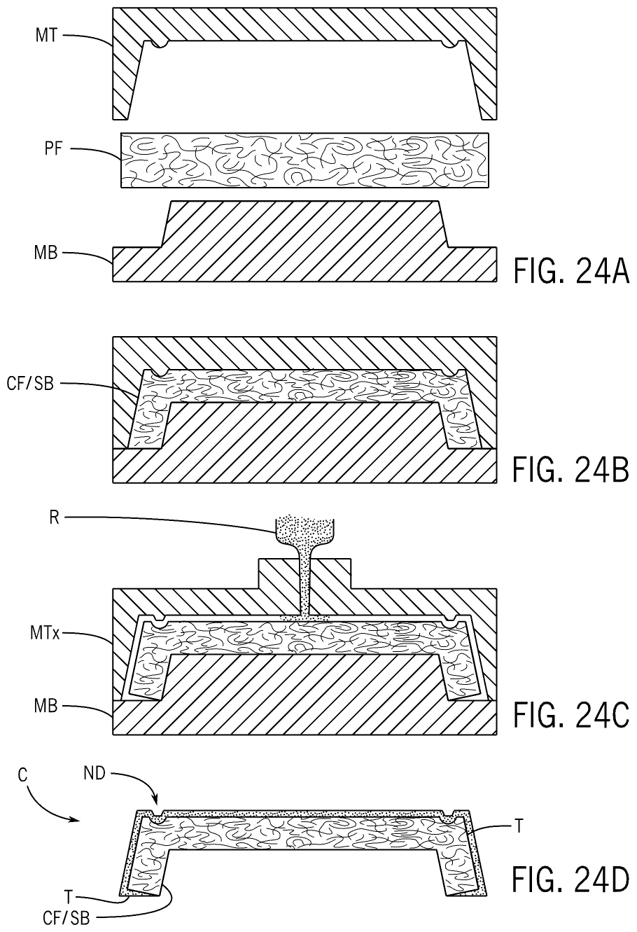

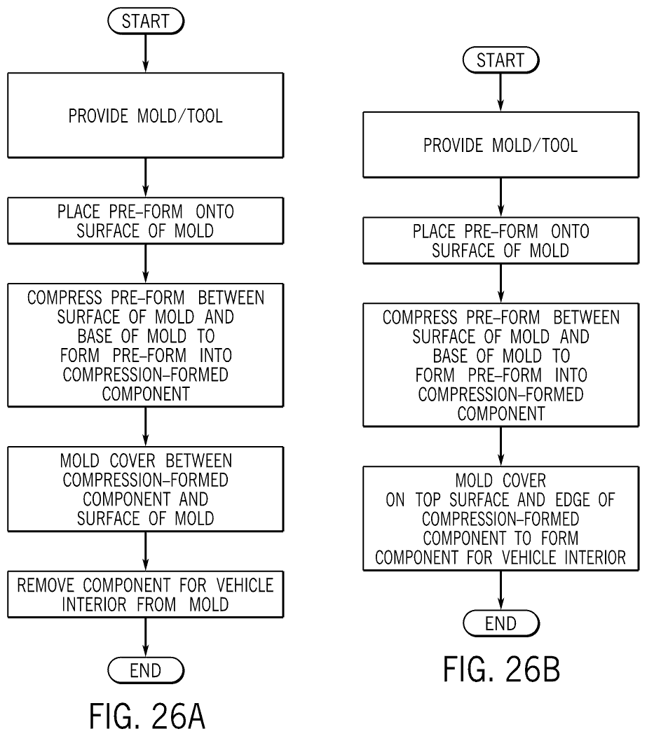

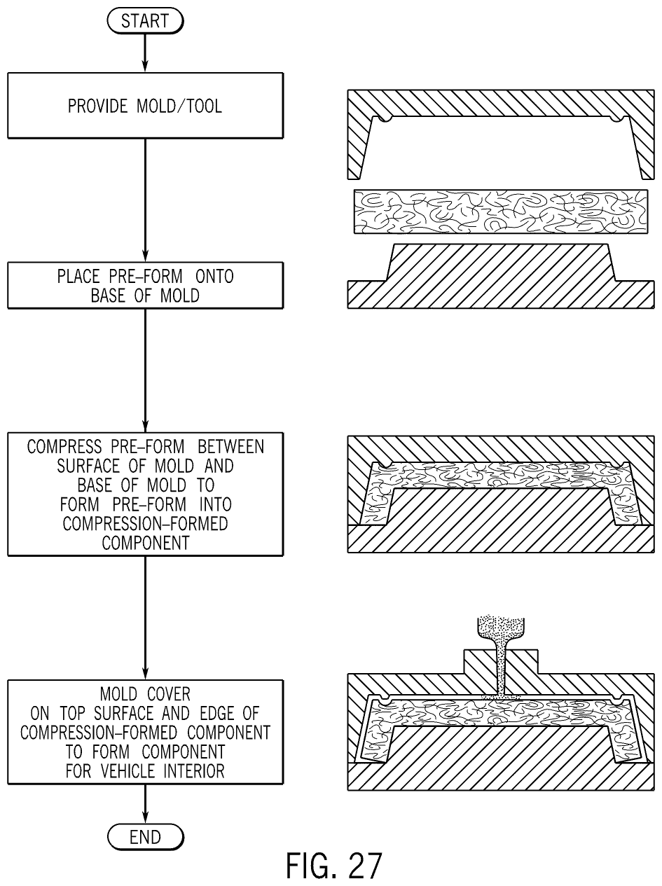

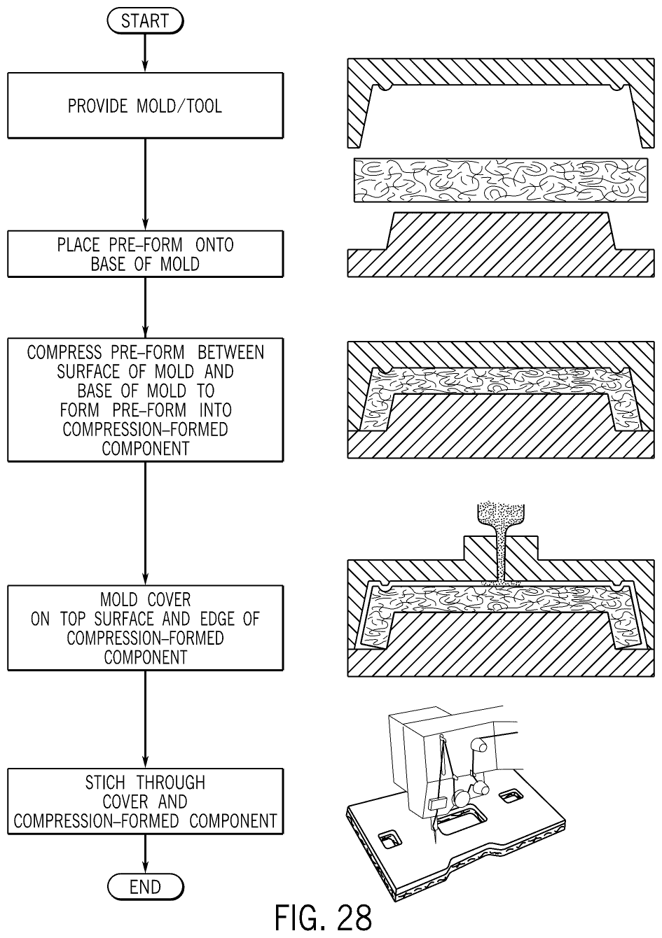

As indicated schematically according to an exemplary embodiment in FIGS. 20A-20D and 24A-24D, the composite structure of the component may be formed in a mold tool comprising a mold bottom MB and a mold top MT to compression form substrate SB from a preform panel PF and a mold top MTx for molding of cover T as a cover layer formed on the substrate SB (e.g. injection molded with a material shown as resin R); the substrate may comprise a base layer. See also FIGS. 26A-26B, 27 and 28. As indicated schematically according to an exemplary embodiment in FIGS. 20A-20D and 24A-24D, the composite structure may comprise the cover layer formed on the substrate; the composite structure may comprise the cover layer molded on the substrate; the composite structure may comprise the cover layer molded around the substrate; the composite structure may comprise the cover layer molded partially around the substrate; the composite structure may comprise the cover layer molded laterally around the substrate; the composite structure may comprise the cover layer molded on and at least partially under the substrate. See also FIGS. 26A-26B, 27 and 28. As indicated schematically according to an exemplary embodiment in FIGS. 20A-20D and 24A-24D, cover T may comprise a formed feature such as a projection PN (see FIGS. 20C-20D) and/or an indentation (see FIGS. 24C and 24D); cover T may comprise an injection molded thermoplastic material such as resin R; cover T may comprise an injection molded material formed with the features. As indicated schematically according to an exemplary embodiment in FIGS. 20A-20D and 24A-24D, mold tool/mold top MT may be configured to form features in the substrate; mold tool/mold top MTx may be configured to form features in the cover. See also FIGS. 26A-26B, 27 and 28.

As shown schematically according to an exemplary embodiment in FIGS. 2A-2C, 3, 4 and 23A-23B, a component C for a vehicle interior may comprise a composite structure comprising a substrate SB and a cover T; substrate SB may comprise a fiber panel CF; cover T may comprise a cover layer/skin layer providing an exterior surface TX; the cover may comprise a feature FT such as an indentation/recess ND and/or a projection/protrusion PN. See FIGS. 2C, 5, 6, 7, 8, 9, 10, 11, 12, 13, 14, 15, 16, 17 and 18. The composite structure may comprise a feature FT such as a stitch pattern ST formed into cover T and substrate SB; the stitch pattern may provide a visual/decorative effect; the decorative effect may comprise a simulated seam (e.g. French or deck seam). See FIGS. 2A-2C, 4, 11, 12, 13, 14, 15, 16, 17 and 18. Feature FT may comprise an image or indicia at the exterior surface. See FIGS. 2A-2C, 3, 4 and 23A-23B. Feature FT may comprise a groove and/or a rib. See FIGS. 2A-2C, 3 and 4. The cover may comprise a thermoplastic material molded on the substrate; the cover may be generally opaque and may be softer than the substrate; the cover may comprise a TPE, TPV, or PU material.

Component C may comprise an instrument panel, dashboard, cockpit, door panel, steering wheel, console, knee bolster, trim component, etc.

### Exemplary Embodiments-A

According to an exemplary embodiment as shown schematically in the FIGURES, a component for a vehicle interior may comprise a composite structure comprising a substrate and a cover. The substrate may comprise a panel. The cover may comprise a cover layer. The cover layer may comprise an inner surface and an outer surface. The outer surface of the cover layer may comprise an exterior surface for the composite structure. The cover layer may comprise a feature in the outer surface of the cover layer. The panel may comprise a fiber panel. The substrate may comprise a compressed fiber panel. The feature of the cover layer may comprise at least one of (a) an indentation in the outer surface of the cover layer and (b) a projection in the outer surface of the cover layer. The cover layer may comprise a projection in the outer surface of the cover layer. The cover layer may comprise a recess in the outer surface of the cover layer. The feature of the cover layer may comprise a recess in the outer surface of the cover layer and a projection in the outer surface of the cover layer. The recess may be formed in the outer surface of the cover layer. The projection may be formed in the outer surface of the cover layer. The feature of the cover layer may comprise a groove in the outer surface of the cover layer. The feature of the cover layer may comprise a rib on the outer surface of the cover layer. The feature of the cover layer may comprise an indentation in the outer surface of the cover layer and a rib in the outer surface of the cover layer. The feature of the cover layer may be below the exterior surface of the cover layer. The feature of the cover layer may comprise an indentation below the exterior surface of the cover layer. The feature of the cover layer may be above the exterior surface of the cover layer. The feature of the cover layer may comprise a projection above the exterior surface of the cover layer. The cover may comprise a resin. The cover layer may comprise a skin layer. The inner surface of the cover layer may be coupled to the substrate. The cover layer may be formed on the substrate. The cover layer may be molded on the substrate. The cover layer may be molded around the substrate. The composite structure may comprise a stitch pattern. The stitch pattern may be formed into the cover layer and the substrate. The feature of the cover layer may comprise a stitch pattern provided at the outer surface of the cover layer. The stitch pattern may comprise a stitch through the inner surface of the cover layer. The stitch pattern may be within a recess at the outer surface of the substrate. The stitch pattern may be provided through a top surface of the substrate. The stitch pattern may be below the outer surface of the cover layer. The stitch pattern may be above the outer surface of the cover layer. The stitch pattern may be within a groove in the outer surface of the cover layer. A feature may be provided in a top surface of the substrate. The feature in the top surface of the substrate may comprise at least one of a projection or a recess. The substrate may comprise a structural substrate. The structural substrate may comprise a compression-formed panel. The compression-formed panel of the structural substrate may comprise a rigid compressed fiber panel. The substrate may comprise a semi-rigid compressed fiber panel. The cover layer may comprise a material softer than a material of the substrate. The composite structure may be configured to provide a decorative effect; the decorative effect may comprise a stitch pattern. The composite structure may comprise a stitch pattern; the stitch pattern may be formed into the cover layer and the substrate. The stitch pattern may be adjacent the feature of the cover layer. The stitch pattern may be in a groove in the outer surface of the cover layer. The stitch pattern and the feature of the cover layer may be configured to provide a decorative effect. The stitch pattern and the feature of the cover layer may be configured to provide a visual effect; the visual effect may comprise at least one of: (a) a simulated seam; (b) a simulated French seam; (c) a simulated deck seam. The feature of the cover layer may comprise a projection and/or an indentation. The composite structure may comprise a stitch pattern adjacent to the feature of the cover layer. The composite structure may comprise a stitch pattern at the feature of the cover layer. The composite structure may comprise a stitch pattern through the feature of the cover layer. The feature of the cover layer may comprise at least one of (a) indicia; (b) an image; (c) an icon; (d) a logo. The composite structure may comprise the cover layer formed on the substrate; the feature of the cover layer may be configured to provide the exterior surface of the cover layer with a visual effect. The composite structure may comprise the cover layer (a) formed on the substrate or (b) molded on the substrate. The composite structure may comprise the cover layer (a) molded partially around the substrate; (b) molded laterally around the substrate; (c) molded on and at least partially under the substrate. The cover layer may be molded on the substrate; the cover layer may comprise an injection molded thermoplastic material. The cover layer may comprise at least one of (a) a TPE material; (b) a TPV material; (c) a PU material. The feature of the cover layer may comprise a formed projection. The formed projection may comprise at least one of (a) an image; (b) an icon. The feature of the cover layer may comprise a formed recess. The composite structure may be configured to provide an opening for deployment of an airbag through the opening. The component may comprise at least one of (a) an instrument panel; (b) a dashboard; (c) a door panel; (d) a steering wheel assembly; (e) a console; (f) a cockpit; (g) a knee bolster; (h) a trim component.

According to an exemplary embodiment as shown schematically in the FIGURES, a component for a vehicle interior may comprise a substrate formed from a fiber panel; and a cover for the substrate comprising a skin layer. The skin layer may comprise an inner surface coupled to the substrate and an outer surface providing an exterior surface. The skin layer may comprise at least one of: (a) an indentation in the outer surface of the skin layer; (b) a protrusion in the outer surface of the skin layer. The indentation may be formed as a recess in the outer surface of the skin layer. The skin layer may be molded on the substrate. The skin layer may comprise an injection molded thermoplastic material. The skin layer may comprise at least one of (a) a TPE material; (b) a TPV material; (c) a PU material. The skin layer may comprise a skin material; the skin material may be softer than the substrate. The component may comprise a stitch pattern formed into the skin layer and the substrate. The stitch pattern and the indentation in the outer surface of the skin layer may be configured to provide a visual effect comprising at least one of: (a) a simulated seam; (b) a simulated French seam; (c) a simulated deck seam. The stitch pattern and the protrusion in the outer surface of the skin layer may be configured to provide a visual effect comprising at least one of: (a) a simulated seam; (b) a simulated French seam; (c) a simulated deck seam. The protrusion in the outer surface of the skin layer may comprise at least one of (a) an image; (b) an icon.

According to an exemplary embodiment as shown schematically in the FIGURES, a component for a vehicle interior formed in a mold may comprise (a) a substrate comprising a compression-formed component; and (b) a cover comprising a skin layer. The compression-formed component may be formed by compressing a fiber panel between a first surface of the mold and a second surface of the mold. The skin layer may be formed by molding the skin layer on the compression-formed component. The cover may comprise a feature comprising at least one of (a) a recess in an outer surface of the cover and (b) a projection in the outer surface of the cover. The component may comprise a composite structure comprising the substrate and the cover; the composite structure may comprise a stitch pattern adjacent to the feature of the cover.

According to an exemplary embodiment as shown schematically in the FIGURES, a method of manufacturing a component for a vehicle interior in a mold may comprise: (a) providing a pre-form substrate; (b) disposing the pre-form substrate onto a first surface of the mold; (c) compressing the pre-form substrate between the first surface of the mold and a second surface of the mold to form the pre-form substrate into a compression-formed component having a shape corresponding to a first contour of the first surface and a second contour of the second surface; and (d) molding a skin layer on the compression-formed component. The step of molding a skin layer on the compression-formed component may comprise molding the skin layer between the compression-formed component and a third surface of the mold; the third surface of the mold may be configured to form at least one of: (a) an indentation in the outer surface of the skin layer; (b) a protrusion in the outer surface of the skin layer. The step of molding a skin layer on the compression-formed component may comprise molding the skin layer on a top surface of the compression-formed component and on an edge of the compression-formed component. The method may comprise a step of forming a stitch pattern into the skin layer and the compression-formed component. A component made by the method may comprise a composite structure comprising a structural substrate formed from the pre-form substrate and a cover comprising the skin layer. An outer surface of the skin layer of the cover may comprise an exterior surface of the composite structure; the composite structure may comprise a stitch pattern adjacent to a feature of the cover layer.

### Exemplary Embodiments-B

According to an exemplary embodiment as shown schematically in the FIGURES, a component for a vehicle interior may comprise a composite structure comprising a substrate and a cover. The substrate may comprise a panel. The cover may comprise a cover layer. The cover layer may comprise an inner surface and an outer surface. The outer surface of the cover layer may comprise an exterior surface for the composite structure. The cover layer may comprise a feature in the outer surface of the cover layer. The panel may comprise a fiber panel. The substrate may be formed from a fiber panel. The substrate may comprise a compressed fiber panel. The feature of the cover layer may comprise at least one of (a) an indentation in the outer surface of the cover layer and (b) a projection in the outer surface of the cover layer. The feature of the cover layer may comprise at least one of (a) a recess in the outer surface of the cover layer and (b) a projection in the outer surface of the cover layer. The cover layer may comprise a projection in the outer surface of the cover layer. The cover layer may comprise a recess in the outer surface of the cover layer. The feature of the cover layer may comprise a recess in the outer surface of the cover layer and a projection in the outer surface of the cover layer. The recess may be formed in the outer surface of the cover layer. The projection may be formed in the outer surface of the cover layer. The feature of the cover layer may comprise a groove in the outer surface of the cover layer. The groove of the cover layer may comprise at least one of (a) a recess in the outer surface of the cover layer and (b) a projection in the outer surface of the cover layer. The groove of the cover layer may comprise a recess in the outer surface of the cover layer and a set of projections in the outer surface of the cover layer. The feature of the cover layer may comprise a rib on the outer surface of the cover layer. The feature of the cover layer may comprise an indentation in the outer surface of the cover layer and a rib in the outer surface of the cover layer. The feature of the cover layer may be below the exterior surface of the cover layer. The feature may comprise an indentation below the exterior surface of the cover layer. The feature of the cover layer may be above the exterior surface of the composite structure. The feature may comprise a projection above the exterior surface of the composite structure. The cover may comprise a skin. The cover may comprise a resin. The cover layer may comprise a skin layer. The inner surface of the cover layer may be coupled to the substrate. The cover layer may be formed on the substrate. The cover layer may be molded on the substrate. The cover layer may be molded on and around the substrate. The cover layer may be molded around the substrate. The cover layer may be applied on the substrate. The cover layer may be applied over the substrate. The cover layer may be wrapped around the substrate. The cover layer may be partially wrapped around the substrate. The composite structure may comprise a stitch pattern. The stitch pattern may be formed into the cover layer and the substrate. The feature of the cover layer may comprise a stitch pattern provided at the outer surface of the cover layer. The stitch pattern may comprise a stitch through the inner surface of the cover layer. The stitch pattern may be within a recess at the outer surface of the substrate. The stitch pattern may be provided through a top surface of the substrate. The stitch pattern may be below the outer surface of the cover layer. The stitch pattern may be above the exterior surface of the composite structure. The stitch pattern may be below the exterior surface of the composite structure. The stitch pattern may be above the outer surface of the cover layer. The stitch pattern may be within a groove in the outer surface of the cover layer. A feature may be provided in the top surface of the substrate. The feature may be formed in the top surface of the substrate. The feature in the top surface of the substrate may comprise at least one of a projection or a recess. The feature may be formed in the panel of the substrate. The substrate may comprise a structural substrate. The structural substrate may comprise a compression-formed panel. The compression-formed panel may comprise a compression formed fiber panel. The panel of the structural substrate may comprise a rigid compressed fiber panel. The panel of the substrate may comprise a semi-rigid compressed fiber panel. The panel of the substrate may comprise a semi-rigid compressed fiber panel; the cover layer may comprise a material softer than the material of the panel of the substrate. The cover layer may comprise a material softer than the material of the substrate. The panel may comprise a fiber panel. The panel may comprise a fiber panel comprising natural fibers. The composite structure may be configured to provide a decorative effect. The outer surface of the cover may be configured to provide a decorative effect. The exterior surface of the composite structure may be configured to provide a decorative effect. The composite structure may be configured to provide a decorative effect; the decorative effect may comprise a stitch pattern. The composite structure may comprise a stitch pattern; the stitch pattern may be formed into the cover layer and the substrate. The stitch pattern may be adjacent the feature in the outer surface of the cover layer. The stitch pattern may be in a groove in the outer surface of the cover layer. The stitch pattern and the feature in the outer surface of the cover layer may be configured to provide a decorative effect. The feature may comprise a projection and/or an indentation. The decorative effect may comprise a visual effect. The stitch pattern and the feature in the outer surface of the cover layer may be configured to provide a visual effect. The visual effect may comprise at least one of: (a) a simulated seam; (b) a simulated French seam; (c) a simulated deck seam. The stitch pattern and the feature in the outer surface of the cover layer may be configured to provide a visual effect comprising at least one of: (a) a simulated seam; (b) a simulated French seam; (c) a simulated deck seam. The visual effect may comprise a decorative effect. The composite structure may comprise a stitch pattern adjacent to the feature of the cover layer. The composite structure may comprise a stitch pattern at the feature of the cover layer. The composite structure may comprise a stitch pattern in the feature of the cover layer. The composite structure may comprise a stitch pattern through the feature of the cover layer. The substrate may comprise a feature at a rear side of the panel. The substrate may comprise a feature formed at a rear side of the panel. The feature at the rear side of the panel may comprise at least one of (a) a resin; (b) a thermoplastic resin; (c) polypropylene; (d) acrylonitrile butadiene styrene; (e) polycarbonate. The feature at the rear side of the panel may be molded on the rear side of the panel. The substrate may comprise a set of projections formed on a rear side of the panel. The set of projections formed on the rear side of the panel may comprise at least one of (a) a resin; (b) a thermoplastic resin; (c) polypropylene; (d) acrylonitrile butadiene styrene; (e) polycarbonate. The set of projections formed on the rear side of the panel may comprise at least one of (a) a rib; (b) a set of ribs; (c) a resin-formed feature; (d) a resin-formed feature molded on the substrate. The set of projections formed on the rear side of the panel may comprise at least one projection. The feature on the outer surface of the cover layer may comprise indicia. The indicia may comprise at least one of (a) an image; (b) an icon; (c) a logo. The projection on the outer surface of the cover layer may comprise at least one of (a) an image; (b) an icon. The recess at the outer surface of the cover layer may comprise a groove. The composite structure may comprise the cover layer formed on the substrate; the feature of the cover layer may be configured to provide the exterior surface of the composite structure with a visual effect. The exterior surface of the cover may comprise a decorative effect. The composite structure may comprise the cover layer formed on the base layer of the substrate; the feature of the cover layer of the cover may comprise a stitch pattern visible at the exterior surface of the composite structure. The stitch pattern may comprise a decorative effect visible at the exterior surface of the composite structure. The composite structure may comprise the cover layer formed on the substrate. The composite structure may comprise the cover layer molded on the substrate. The composite structure may comprise the cover layer molded around the substrate. The composite structure may comprise the cover layer molded partially around the substrate. The composite structure may comprise the cover layer molded laterally around the substrate. The composite structure may comprise the cover layer molded on and at least partially under the substrate. The cover layer may be molded on the substrate; the cover layer may comprise an injection molded thermoplastic material. The cover layer may comprise a generally opaque material. The cover layer may comprise at least one of (a) a TPE material; (b) a TPV material; (c) a PU material. The feature of the cover layer may comprise a formed projection. The feature of the cover layer may comprise a formed recess. The formed projection may comprise a protrusion. The formed recess may comprise an indentation. The feature of the cover layer may comprise an integrally-formed projection. The feature of the cover layer may comprise an integrally-formed recess. The feature at the outer surface of the cover layer may comprise a protrusion in the inner surface of the cover layer; the protrusion may be configured to fit within an indentation in a top surface of the substrate. The composite structure may be configured to facilitate formation of an opening for deployment of an airbag into the vehicle interior. The composite structure may be configured to facilitate formation of an airbag door to provide an opening for deployment of an airbag into the vehicle interior. The composite structure may be configured to provide an opening for deployment of an airbag through the opening. The composite structure may be configured for contact from the airbag to form the opening for deployment of the airbag. A rear side of the fiber panel may be configured for contact from the airbag to establish the opening for deployment of the airbag. The composite structure may be configured to support an airbag module comprising the airbag. The panel may be configured to support an airbag module comprising the airbag. A feature at a rear side of the panel may comprise at least one of (a) an airbag chute; (b) a passage for the airbag; (c) a feature configured to facilitate the opening; (d) a structure for an airbag door; (e) a set of ribs configured to establish a seam for an airbag door; (f) a weld rib configured to couple an airbag chute to the panel. The component may comprise at least one of (a) an instrument panel; (b) a dashboard; (c) a door panel; (d) a steering wheel assembly; (e) a console; (f) a cockpit; (g) a knee bolster; (h) a trim component.

According to an exemplary embodiment as shown schematically in the FIGURES, a component for a vehicle interior may comprise a substrate formed from a fiber panel; and a cover for the substrate comprising a skin layer. The skin layer may comprise an inner surface coupled to the substrate and an outer surface providing an exterior surface. The skin layer may comprise at least one of: (a) an indentation in the outer surface of the skin layer; (b) a protrusion in the outer surface of the skin layer. The protrusion may comprise a projection; the indentation may comprise a recess. The substrate and the cover may comprise a composite structure configured to provide the exterior surface. The skin layer may comprise a cover layer. The indentation may be formed as a recess in the outer surface of the skin layer. The skin layer may comprise a protrusion in the inner surface of the skin layer opposite the indentation in the outer surface of the skin layer. The protrusion in the inner surface of the skin layer may be configured to fit within an indentation in a top surface of the substrate. The indentation in the top surface of the substrate may be formed in the fiber panel. The skin layer may be molded on the substrate. The skin layer may comprise an injection molded thermoplastic material. The skin layer may comprise a generally opaque material. The skin layer may comprise at least one of (a) a TPE material; (b) a TPV material; (c) a PU material. The skin layer may comprise a skin material; the skin material may be softer than the substrate. The fiber panel may comprise a panel comprising fibers. The fiber panel may be configured to provide an opening for deployment of an airbag through the opening. A rear side of the fiber panel may be configured for contact from the airbag to establish the opening for deployment of the airbag. The rear side of the panel may be configured to support an airbag module comprising the airbag. The substrate may comprise at least one feature at a rear side of the panel. The at least one feature may comprise at least one of (a) a resin; (b) a thermoplastic resin; (c) polypropylene; (d) acrylonitrile butadiene styrene; (e) polycarbonate. The at least one feature may be formed on the rear side of the panel. The at least one feature may comprise at least one of (a) an airbag chute; (b) a passage for the airbag; (c) a feature configured to facilitate the opening; (d) a structure for an airbag door; (e) a set of ribs configured to establish a seam for an airbag door; (f) a weld rib configured to couple an airbag chute to the panel. The substrate may comprise a compression-formed component from the fiber panel. The component may comprise a stitch pattern. The stitch pattern may be formed into the skin layer and the substrate. The stitch pattern may be adjacent to the protrusion in the outer surface of the skin layer. The stitch pattern and the protrusion in the outer surface of the skin layer may be configured to provide a visual effect comprising at least one of: (a) a simulated seam; (b) a simulated French seam; (c) a simulated deck seam. The substrate may comprise at least one feature formed on a rear side of the panel. The at least one feature may comprise at least one of (a) a resin; (b) a thermoplastic resin; (c) polypropylene; (d) acrylonitrile butadiene styrene; (e) polycarbonate. The at least one feature may comprise at least one of (a) a rib; (b) a set of ribs; (c) a resin-formed feature; (d) a resin-formed feature molded on the substrate. The protrusion in the outer surface of the skin layer may comprise at least one of (a) an image; (b) an icon. The indentation in the outer surface of the skin layer may comprise a groove. The component may comprise a composite structure comprising the substrate and the cover; the outer surface of the cover may comprise the exterior surface of the composite structure. The skin layer may comprise a cover layer. The component may comprise at least one of (a) an instrument panel; (b) a dashboard; (c) a door panel; (d) a steering wheel assembly; (e) a console; (f) a cockpit; (g) a knee bolster; (h) a trim component.

According to an exemplary embodiment as shown schematically in the FIGURES, a component for a vehicle interior formed in a mold may comprise (a) a substrate comprising a compression-formed component; and (b) a cover comprising a skin layer. The compression-formed component may be formed by compressing a fiber panel between a first surface of the mold and a second surface of the mold. The skin layer may be formed by molding the skin layer on the compression-formed component. The component may comprise a composite structure comprising the substrate and the cover. An outer surface of the skin layer of the cover may comprise an exterior surface of the composite structure. The skin layer may comprise a cover layer. The composite structure may comprise a stitch pattern adjacent to a feature of the cover layer. The composite structure may comprise a stitch pattern at the feature of the cover layer. The feature of the cover layer may comprise at least one of (a) a recess in the outer surface of the cover layer and (b) a projection in the outer surface of the cover layer. The composite structure may be configured to facilitate formation of an airbag door to provide an opening for deployment of an airbag into the vehicle interior.

According to an exemplary embodiment as shown schematically in the FIGURES, a method of manufacturing a component for a vehicle interior in a mold may comprise (a) providing a pre-form substrate; (b) disposing the pre-form substrate onto a first surface of the mold; (c) compressing the pre-form substrate between the first surface of the mold and a second surface of the mold to form the pre-form substrate into a compression-formed component having a shape corresponding to a first contour of the first surface and a second contour of the second surface; and (d) molding a skin layer on the compression-formed component. The method may comprise a step of injecting resin into the mold to form a feature on a rear side of the compression-formed component. The step of molding a skin layer on the compression-formed component may comprise molding the skin layer between the compression-formed component and a third surface of the mold. The third surface of the mold may be configured to form at least one of: (a) an indentation in the outer surface of the skin layer; (b) a protrusion in the outer surface of the skin layer. The step of molding a skin layer on the compression-formed component may comprise molding the skin layer on a top surface of the compression-formed component and on an edge of the compression-formed component. The step of compressing the pre-form substrate between the first surface of the mold and the second surface of the mold may comprise forming an indentation a top surface of the compression-formed component. A component made by the method may comprise a composite structure comprising a structural substrate formed from the pre-form substrate and a cover comprising the skin layer. An outer surface of the skin layer of the cover may comprise an exterior surface of the composite structure. The skin layer may comprise a cover layer. The composite structure may comprise a stitch pattern adjacent to a feature of the cover layer. The composite structure may comprise a stitch pattern at the feature of the cover layer. The feature of the cover layer may comprise at least one of (a) a recess in the outer surface of the cover layer and (b) a projection in the outer surface of the cover layer. The composite structure may be configured to facilitate formation of an airbag door to provide an opening for deployment of an airbag into the vehicle interior.

### Exemplary Embodiments-C

Referring to FIGS. 1A and 1B, a vehicle V is shown including an interior I with an instrument panel IP and door panels DP. According to an exemplary embodiment, interior components of vehicle V such as instrument panel IP and door panels DP may include trim panels. According to an exemplary embodiment, components such as instrument panel IP and door panels DP (and other trim components) may provide visible surfaces in the vehicle interior of vehicle V.

As indicated schematically according to an exemplary embodiment in FIG. 2A, a component such as an instrument panel IP or a steering wheel may comprise a substrate covered by a cover. The cover may comprise visible stitching. As indicated schematically according to an exemplary embodiment in FIG. 2B, a component such as a door panel may comprise a substrate covered by a cover. The cover may comprise visible stitching.

According to an exemplary embodiment as shown schematically in FIG. 3, a component C for a vehicle interior may comprise a substrate SB formed from a compression-formed component CF. Component C may comprise a base B shown as a housing/chute CH (e.g. for an airbag). Base B may be coupled to substrate SB. Substrate SB may be covered by a cover T. Cover T may comprise a protrusion PN and/or an indentation ND.

According to an exemplary embodiment as shown schematically in FIG. 4, component C may comprise stitching ST shown as a stitch pattern. The stitch pattern may be formed into cover T and substrate SB. The stitch pattern may be adjacent protrusion PN. The stitch pattern may be adjacent recess RS. The stitch pattern and protrusion PN and/or recess RS may provide a visual effect comprising at least one of: (a) a simulated seam; (b) a simulated French seam; (c) a simulated deck seam.

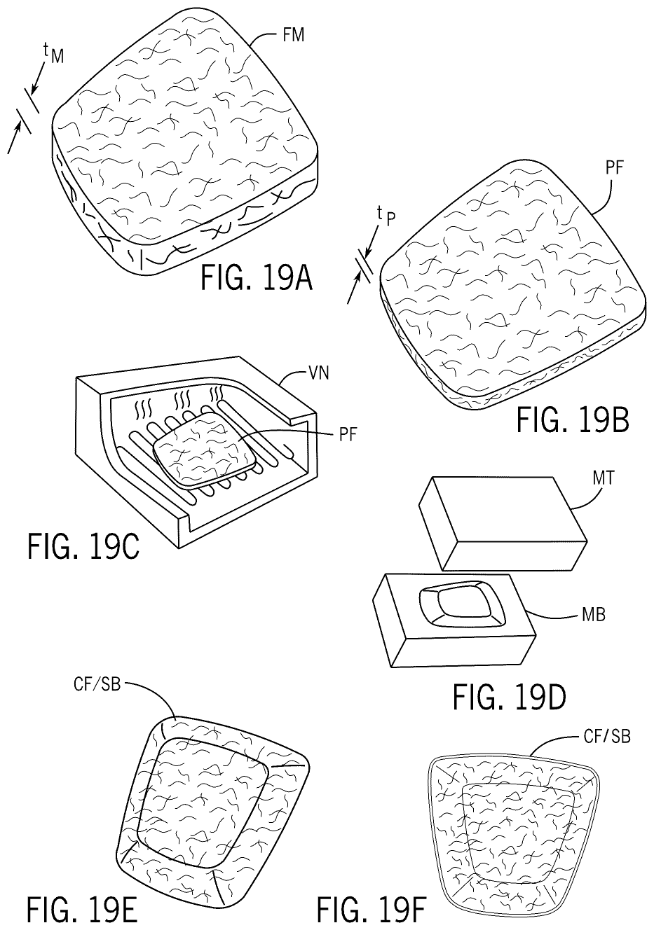

According to an exemplary embodiment as shown schematically in FIG. 19A, a fiber mat FM may include a combination of fibers (e.g. natural and/or synthetic fibers) and thermoplastic resin (e.g. polypropylene (PP), acrylonitrile butadiene styrene (ABS), polycarbonate (PC), etc.). According to an exemplary embodiment, fiber mat FM may have a thickness tM. According to an exemplary embodiment, fiber mat FM may be heated to induce the thermoplastic resin to liquefy. According to an exemplary embodiment as shown schematically in FIG. 19B, fiber mat FM may be heated and partially compressed into a pre-form PF. According to an exemplary embodiment, fiber mat FM may be placed into a low-temperature mold and compression molded into a desired shape. According to an exemplary embodiment, as the compressed fiber mat cools, the thermoplastic within the fiber mat may solidify to establish a substantially rigid composite panel. According to an exemplary embodiment, the pre-form may have a thickness tP, which may be smaller than thickness tM.

According to an exemplary embodiment, fiber mat FM may comprise a combination of structural fibers and thermoset resin (e.g. epoxy, polyester, etc.). According to an exemplary embodiment, fiber mat FM may be compressed within a heated mold to form a partially compressed fiber mat with a desired shape and to induce curing of the thermoset resin. According to an exemplary embodiment, a substantially rigid composite panel may be formed after the thermoset resin is cured.

According to an exemplary embodiment as shown schematically in FIG. 19C, pre-form PF comprising a compressed fiber mat may be heated in an oven VN. As shown schematically in FIG. 19D, the heated pre-form may be transferred into a mold having a mold top MT and a mold bottom MB. According to an exemplary embodiment, a compression-formed component CF shown as a substrate SB may be produced by a process of compression forming pre-form PF. The process may also comprise injection molding. According to an exemplary embodiment, heated pre-form may be further compressed into a fiber panel; plastic resin may be injected on the back side of fiber panel to form an ancillary feature. According to an exemplary embodiment, compression-formed component CF may provide ancillary features such as plastic ribs on the backside of compression-formed component CF to improve structural integrity and rigidity. According to an exemplary embodiment, compression-formed component CF may be configured to support an airbag chute (i.e. airbag module) and/or an airbag. According to an exemplary embodiment, a plastic rib may be placed at any location on the backside of compression-formed component CF (e.g. along an edge, in the middle, etc.). According to an exemplary embodiment, multiple plastic ribs may be placed at various different locations on the backside of compression-formed component CF.

According to an exemplary embodiment as shown schematically in FIG. 20A, pre-form PF may be placed into a mold having a mold top MT and a mold bottom MB. According to an exemplary embodiment as shown schematically in FIG. 20B, a compression-formed component CF shown as a substrate SB may be produced by a process of compression forming pre-form PF. According to an exemplary embodiment as shown schematically in FIG. 20C, a cover T may be molded on substrate SB. Cover T may comprise a skin layer. Cover T may be formed by injection molding a thermoplastic material on substrate SB. The thermoplastic material may comprise a generally opaque material. The thermoplastic material may comprise at least one of (a) a TPE material; (b) a TPV material; (c) a PU material. Cover T may be molded between substrate SB and a mold top MTx. Mold top MTx may comprise a surface configured to form at least one of: (a) a recess in an outer surface of cover T; (b) a protrusion in an outer surface of cover T. Cover T may be molded on a top surface of substrate SB and on an edge of substrate SB. According to an exemplary embodiment as shown schematically in FIG. 20D, component C may comprise substrate SB formed from a fiber panel and cover T for substrate SB comprising a skin layer. The skin layer may comprise an inner surface coupled to substrate SB and an outer surface providing an exterior surface of component C. The skin layer may comprise at least one of: (a) an indentation ND in an outer surface of the skin layer; (b) a protrusion PN in an outer surface of the skin layer.

Referring to FIGS. 22A-22E, construction/formation of a component C is shown schematically according to an exemplary embodiment. A compression-formed component CF may be formed by compression forming a fiber mat. As shown schematically in FIG. 22A, compression-formed component CF may provide a surface effect comprising a generally rigid form. As shown schematically in FIGS. 22B-22C, compression-formed component CF may be covered with a cover T; as shown schematically in FIG. 22C, component C may provide a surface effect comprising a generally smooth surface and a generally soft form (e.g. from the cover T).

According to an exemplary embodiment as shown schematically in FIG. 13, component C may comprise (a) a compression-formed component CF comprising a substrate SB and (b) a cover T comprising a skin layer. The skin layer may comprise an inner surface coupled to substrate SB and an outer surface providing an exterior surface of component C. The skin layer may comprise an indentation ND in an outer surface of the skin layer. Component C may comprise stitching ST shown as a stitch pattern. The stitch pattern may be formed into cover T and substrate SB. The stitch pattern may be adjacent recess RS. The stitch pattern and recess RS may provide a visual effect comprising at least one of: (a) a simulated seam; (b) a simulated French seam; (c) a simulated deck seam.

According to an exemplary embodiment as shown schematically in FIG. 15, component C may comprise (a) a compression-formed component CF comprising a substrate SB and (b) a cover T comprising a skin layer. The skin layer may comprise an inner surface coupled to substrate SB and an outer surface providing an exterior surface of component C. The skin layer may comprise a protrusion PN in an outer surface of the skin layer. Component C may comprise stitching ST shown as a stitch pattern. The stitch pattern may be formed into cover T and substrate SB. The stitch pattern may be adjacent protrusion PN. The stitch pattern and protrusion PN may provide a visual effect comprising at least one of: (a) a simulated seam; (b) a simulated French seam; (c) a simulated deck seam.

According to an exemplary embodiment as shown schematically in FIG. 17, component C may comprise (a) a compression-formed component CF comprising a substrate SB and (b) a cover T comprising a skin layer. The skin layer may comprise an inner surface coupled to substrate SB and an outer surface providing an exterior surface of component C. The skin layer may comprise a protrusion PN in an outer surface of the skin layer. Substrate SB comprise a protrusion PN in an outer surface of substrate SB. Protrusion PN in the outer surface of the skin layer may be formed by molding the skin layer on protrusion PN in the outer surface of substrate SB. Component C may comprise stitching ST shown as a stitch pattern. The stitch pattern may be formed into cover T and substrate SB. The stitch pattern may be adjacent protrusion PN. The stitch pattern and protrusion PN may provide a visual effect comprising at least one of: (a) a simulated seam; (b) a simulated French seam; (c) a simulated deck seam.

### Exemplary Embodiments-D

According to an exemplary embodiment as shown schematically in the FIGURES, a component C for a vehicle interior may comprise a substrate SB formed from a fiber panel and a cover T for the substrate comprising a skin layer. The skin layer may comprise an inner surface coupled to the substrate and an outer surface providing an exterior surface of the component. The skin layer may comprise at least one of: (a) an indentation ND in the outer surface of the skin layer; (b) a protrusion PN in the outer surface of the skin layer. The indentation may be formed as a recess in the skin layer. The skin layer may comprise a protrusion PN in the inner surface of the skin layer opposite the indentation in the outer surface of the skin layer. The protrusion in the inner surface of the skin layer may be configured to fit within an indentation ND in a top surface of the substrate. The indentation in the top surface of the substrate may be formed in the fiber panel. The skin layer may be molded on the substrate. The skin layer may comprise an injection molded thermoplastic material. The skin layer may comprise a generally opaque material. The skin layer may comprise at least one of (a) a TPE material; (b) a TPV material; (c) a PU material. The skin layer may comprise a skin material; the skin material may be softer than the substrate. The fiber panel may comprise a panel comprising fibers. The fiber panel may be configured to provide an opening for deployment of an airbag through the opening. A rear side of the fiber panel may be configured for contact from the airbag to establish the opening for deployment of the airbag. The rear side of the panel may be configured to support an airbag module comprising the airbag. The substrate may comprise at least one feature at a rear side of the panel. The at least one feature may comprise at least one of (a) a resin; (b) a thermoplastic resin; (c) polypropylene; (d) acrylonitrile butadiene styrene; (e) polycarbonate. The at least one feature may be formed on the rear side of the panel. The at least one feature may comprise at least one of (a) an airbag chute; (b) a passage for the airbag; (c) a feature configured to facilitate the opening; (d) a structure for an airbag door; (e) a set of ribs configured to establish a seam for an airbag door; (f) a weld rib configured to couple an airbag chute to the panel. The substrate may comprise a compression-formed component CF from the fiber panel. The component may comprise a stitch pattern ST. The stitch pattern may be formed into the skin layer and the substrate. The stitch pattern may be adjacent the protrusion in the outer surface of the skin layer. The stitch pattern and the protrusion in the outer surface of the skin layer may be configured to provide a visual effect comprising at least one of: (a) a simulated seam; (b) a simulated French seam; (c) a simulated deck seam. The substrate may comprise at least one feature formed on a rear side of the panel. The at least one feature may comprise at least one of (a) a resin; (b) a thermoplastic resin; (c) polypropylene; (d) acrylonitrile butadiene styrene; (e) polycarbonate. The at least one feature may comprise at least one of (a) a rib; (b) a set of ribs; (c) a resin-formed feature; (d) a resin-formed feature molded on the substrate. The protrusion in the outer surface of the skin layer may comprise at least one of (a) an image; (b) an icon. The indentation in the outer surface of the skin layer may comprise a groove. The component may comprise at least one of (a) an instrument panel; (b) a dashboard; (c) a door panel; (d) a steering wheel assembly; (e) a console; (f) a cockpit; (g) a knee bolster; (h) a trim component.

According to an exemplary embodiment as shown schematically in the FIGURES, a component C for a vehicle interior formed in a mold may comprise a substrate SB comprising a compression-formed component CF and a cover T comprising a skin layer. The compression-formed component may be formed by compressing a fiber panel between a first surface of the mold and a second surface of the mold. The skin layer may be formed by molding the skin layer on the compression-formed component.

According to an exemplary embodiment as shown schematically in the FIGURES, a method of manufacturing a component for a vehicle interior in a mold may comprise providing a pre-form substrate PF; disposing the pre-form substrate onto a first surface MB of the mold; compressing the pre-form substrate between the first surface and a second surface MT of the mold to form the pre-form substrate into a compression-formed component having a shape corresponding to a first contour of the first surface and a second contour of the second surface; and molding a skin layer on the compression-formed component. The method may comprise a step of injecting resin into the mold to form a feature on a rear side of the compression-formed component. The method may comprise a step of injecting resin into the mold to form a feature on a rear side of the compression-formed component. The step of molding a skin layer on the compression-formed component may comprise molding the skin layer between the compression-formed component and a third surface MTx of the mold. The third surface of the mold may be configured to form at least one of (a) an indentation ND in the outer surface of the skin layer; (b) a protrusion PN in the outer surface of the skin layer. The step of molding a skin layer on the compression-formed component may comprise molding the skin layer on a top surface of the compression-formed component and on an edge of the compression-formed component. The step of compressing the pre-form substrate between the first surface of the mold and the second surface of the mold may comprise forming an indentation a top surface of the compression-formed component.

According to an exemplary embodiment as shown schematically in FIG. 26A, a method of manufacturing a component for a vehicle interior may comprise providing a mold comprising a first surface, a second surface and a third surface; placing a pre-form onto the first surface of mold; compressing the pre-form between the first surface of the mold and the second surface of mold to form the pre-form into a compression-formed component; molding a cover between the compression-formed component and the third surface of mold; and removing the component for the vehicle interior from the mold.

According to an exemplary embodiment as shown schematically in FIG. 26B, a method of manufacturing a component for a vehicle interior may comprise providing a mold comprising a first surface and a second surface; placing a pre-form onto the first surface of the mold; compressing the pre-form between the first surface of mold and the second surface of mold to form pre-form into a compression-formed component; molding a cover on a top surface and an edge of the compression-formed component to form the component for the vehicle interior.

TABLE A
REFERENCE SYMBOL LIST

| ELEMENT, PART OR COMPONENT | REFERENCE SYMBOL |
|---|---|
| Vehicle | V |
| Interior | I |
| Component | C |
| Door/door panel | DP |
| Instrument panel | IP |
| Steering wheel | SW |
| Stitch/stitch pattern (stitching) | ST |
| Compression-formed panel | CF |
| Substrate/panel | SB |
| Cover (cover layer) | T |
| Exterior surface (cover/cover layer) | TX |
| Feature | FT |
| Projection/protrusion | PN PNx |
| Indentation/recess | ND |
| Base/mounting structure | B |
| structure/housing (airbag chute) | CH |
| Fiber mat | FM |
| Pre-form panel | PF |
| Oven | VN |
| Mold bottom | MB |
| Mold top | MT MTx |
| Resin | R |
| Sewing machine/apparatus | MW |
| Needle of sewing machine/apparatus | NL |
| Top stitch | TS |
| Bottom stitch | BS |
| Nominal thickness of fiber mat | tM |
| Nominal thickness of preform panel | tP |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising:
a composite structure comprising a substrate and a cover;
wherein the substrate comprises a fiber panel formed into a compressed fiber panel;
wherein the cover comprises a cover layer on the substrate;
wherein the cover layer comprises an outer surface comprising an exterior surface for the composite structure;
wherein the cover layer comprises a feature at the outer surface of the cover layer configured to provide a decorative effect;
wherein the feature of the cover layer comprises a stitch pattern provided at the outer surface of the cover layer.

2. The component of claim 1 wherein the stitch pattern comprises a top stitch at the outer surface coupled with a bottom stitch at the substrate.

3. The component of claim 1 wherein the stitch pattern is formed into the cover layer and the substrate.

4. The component of claim 1 wherein the feature of the cover layer comprises an indentation in the outer surface of the cover layer and/or a projection at the outer surface of the cover layer.

5. The component of claim 1 wherein the feature of the cover layer comprises an indentation comprising a recess in the outer surface of the cover layer.

6. The component of claim 1 wherein the feature of the cover layer comprises a groove in the outer surface of the cover layer.

7. The component of claim 1 wherein the feature of the cover layer comprises a rib on the outer surface of the cover layer.

8. The component of claim 1 wherein the feature of the cover layer is below the exterior surface of the cover layer and/or the feature of the cover layer is above the exterior surface of the cover layer.

9. The component of claim 1 wherein the cover layer comprises a skin layer formed on the substrate.

10. The component of claim 9 wherein the skin layer comprises a molded thermoplastic material.

11. The component of claim 1 wherein the stitch pattern comprises a stitch through the cover layer and into the substrate.

12. The component of claim 1 wherein the stitch pattern is within a recess at the outer surface of the cover.

13. The component of claim 1 wherein the substrate comprises a structural substrate; wherein the structural substrate comprises the compressed fiber panel; wherein the compressed fiber panel comprises a compression-formed panel; wherein the compression-formed panel comprises a rigid compressed fiber panel.

14. The component of claim 1 wherein the cover layer comprises a material softer than a material of the substrate.

15. The component of claim 1 wherein the decorative effect of the feature of the cover layer of the cover comprises at least one of (a) indicia; (b) an image; (c) an icon; (d) a logo; (e) a visual effect; (f) a seam; (g) a simulated seam; (h) a simulated stitch; (i) the stitch pattern adjacent a feature; (j) the stitch pattern adjacent an indentation; (k) the stitch pattern adjacent a projection.

16. A component for a vehicle interior comprising:
a composite structure comprising
a substrate formed from a fiber panel;
a cover for the substrate comprising a skin layer;
a stitch pattern formed into the skin layer and the substrate;
wherein the skin layer comprises an inner surface coupled to the substrate and an outer surface providing an exterior surface;
wherein the skin layer comprises a feature comprising an indentation in the outer surface of the skin layer and/or a projection in the outer surface of the skin layer;
wherein the stitch pattern and the feature in the outer surface of the skin layer are configured to provide a visual effect at the exterior surface.

17. The component of claim 16 wherein the stitch pattern comprises a top stitch at the cover surface coupled with a bottom stitch at the substrate.

18. The component of claim 16 wherein the indentation is formed as a recess in the outer surface of the skin layer.

19. The component of claim 16 wherein the skin layer comprises a molded thermoplastic material.

20. The component of claim 16 wherein the skin layer comprises a skin material; wherein the skin material is softer than the substrate.
